(19) United States
(12) Patent Application Publication
(10) Pub. No.: US 2026/0212750 A1
(43) Pub. Date: Jul. 23, 2026

(54) Wearable Proximity Alert Device

(71) Applicant: RHODINE BURGESS, Middle River, MD (US)

(72) Inventor: RHODINE BURGESS, Middle River, MD (US)

(21) Appl. No.: 19/453,666

(22) Filed: Jan. 20, 2026

Related U.S. Application Data
(60) Provisional application No. 63/746,798, filed on Jan. 17, 2025.

(51) Int. Cl. G08B 21/22; G08B 7/06; G01D 5/40; G01S 15/04; G01S 17/04

(52) U.S. Cl. CPC G08B 21/22; G08B 7/06; G01D 5/40; G01S 15/04; G01S 17/04

(57) ABSTRACT

A wearable proximity alert device is a device that helps the user have situational awareness and keep six feet away from other people. The device is provided as a necklace that is comfortable to wear and does not interfere with daily activities. The device includes a wearable conduit, an electronics housing, a plurality of proximity sensors, a microcontroller, a portable power source, and a conduit fastener. The wearable conduit helps secure the device to the user’s body. The wearable conduit also allows the wiring between the electronic and electrical components implemented in the device. The electronics housing protects the microcontroller and the portable power source. The plurality of proximity sensors allows the establishment of a social distancing safe zone around the user. The microcontroller and the portable power source allow the automatic operation of the device. The conduit fastener allows the removable attachment of the device to the user’s body.

The current application claims a priority to the U.S. provisional patent application serial number 63/746,798 filed on January 17, 2025. The current application is filed on the next business day, which is January 20, 2026, while January 17, 2026 was on a weekend and January 19, 2026 was on a national holiday (Birthday of Martin Luther King, Jr.).

### FIELD OF THE INVENTION

The present invention relates generally to wearable electronic devices and personal safety devices. More specifically, the present invention provides a wearable device that alerts when other people or objects are near the user.

### BACKGROUND OF THE INVENTION

Social distancing, also referred to as physical distancing, is a public health practice aimed at limiting close contact between individuals to prevent the spread of contagious diseases, particularly those transmitted through respiratory droplets, such as COVID-19. The concept involves maintaining a safe distance, commonly recommended as six feet or two meters, from others in public spaces. By minimizing direct interactions and avoiding crowded areas, social distancing reduces the likelihood of transmission, especially in settings where individuals may not know they are infected. This practice became globally prominent during the COVID-19 pandemic.

During the COVID-19 pandemic, the practice was implemented alongside other preventive measures such as mask-wearing, hand hygiene, and vaccination campaigns. Social distancing measures included limiting large gatherings, closing schools and workplaces, transitioning to remote activities, and modifying public spaces to ensure proper spacing between individuals. While effective in reducing infection rates, prolonged social distancing has also raised concerns about the impact on mental health and social connectivity, highlighting the need for a balance between safety measures and maintaining a sense of community.

Therefore, the objective of the present invention is to provide a wearable proximity alert device that helps the user maintain social distance and stay safe from viral infections. The present invention is preferably provided as a necklace equipped with several proximity sensors to detect people coming within 6 feet of the wearer. However, the present invention can also be designed to resemble other accessories that the user can comfortably wear. Further, the present invention can be equipped with means to alert the user, such as producing an audible alarm, if a person comes within a 6-foot proximity of the user. Additional features and benefits of the present invention are further discussed in the sections below.

### SUMMARY OF THE INVENTION

The present invention provides a wearable proximity alert device that establishes a 6-foot social distancing safe zone for the wearer. The present invention is a wearable electronic device that alerts the user when others are getting too close during daily activities to prevent viral transmission. In the preferred embodiment, the present invention is designed to resemble a necklace that can be removably put on by the user and comfortably worn while performing everyday activities. Further, the present invention is equipped with several proximity sensors and the necessary electronics that allow the formation of the 6-foot social distancing safe zone around the wearer. Additionally, the present invention can be equipped with means to physically alert the user when a person and/or object has entered the 6-foot social distancing safe zone. For example, the present invention can produce an audible alarm, a soft vibration, a flashing light, etc., to alert the wearer. In other embodiments, the present invention can also be paired to a personal computing device, such as a smartphone or smartwatch, so that the personal computing device emits the alert instead of the present invention.

### BRIEF DESCRIPTION OF THE DRAWINGS

FIG. 1 is a top-front-left perspective view of the wearable proximity alert device of the present invention, wherein the conduit fastener is shown in a closed configuration.

FIG. 2 is a bottom-rear-right perspective view of the wearable proximity alert device of the present invention thereof.

FIG. 3 is a top-front-left perspective view of the wearable proximity alert device of the present invention, wherein the conduit fastener is shown in an open configuration.

FIG. 4 is a bottom-rear-right perspective view of the wearable proximity alert device of the present invention thereof.

FIG. 5 is a top view of the wearable proximity alert device of the present invention, wherein the conduit fastener is shown in a closed configuration.

FIG. 6 is a magnified cross-sectional view of the wearable conduit of the present invention.

FIG. 7 is a box diagram of the electrical connections and the electronic connections of the present invention, wherein the electrical connections are shown in solid lines, and wherein the electronic connections are shown in dashed lines.

### DETAILED DESCRIPTION OF THE INVENTION

All illustrations of the drawings are for the purpose of describing selected versions of the present invention and are not intended to limit the scope of the present invention.

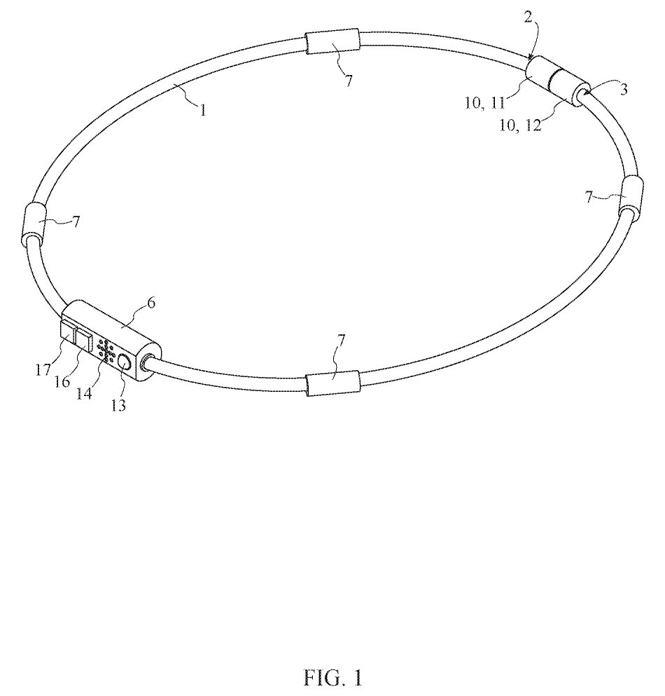

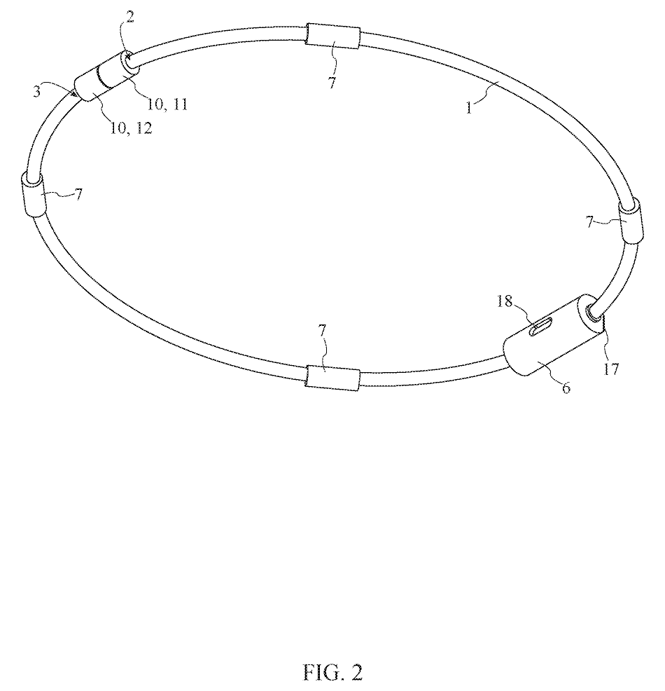

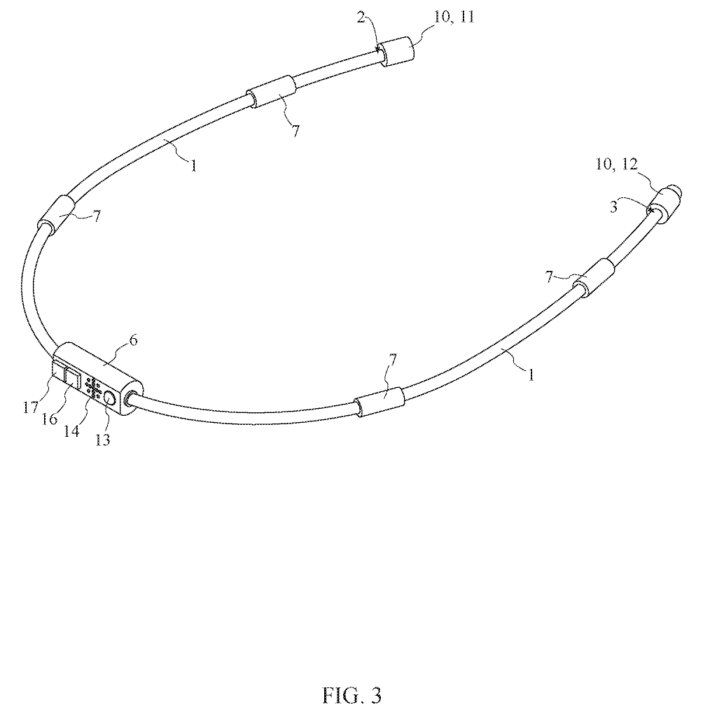

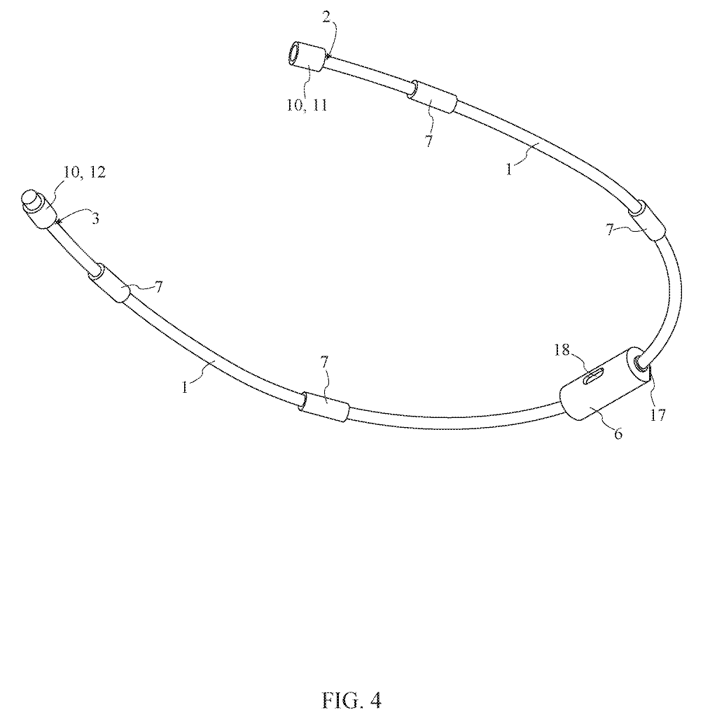

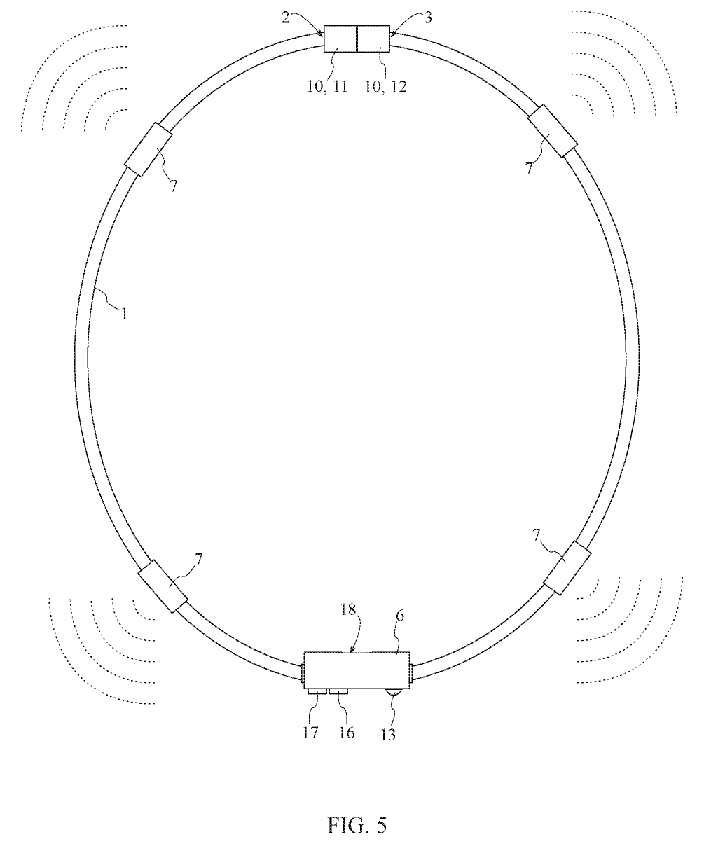

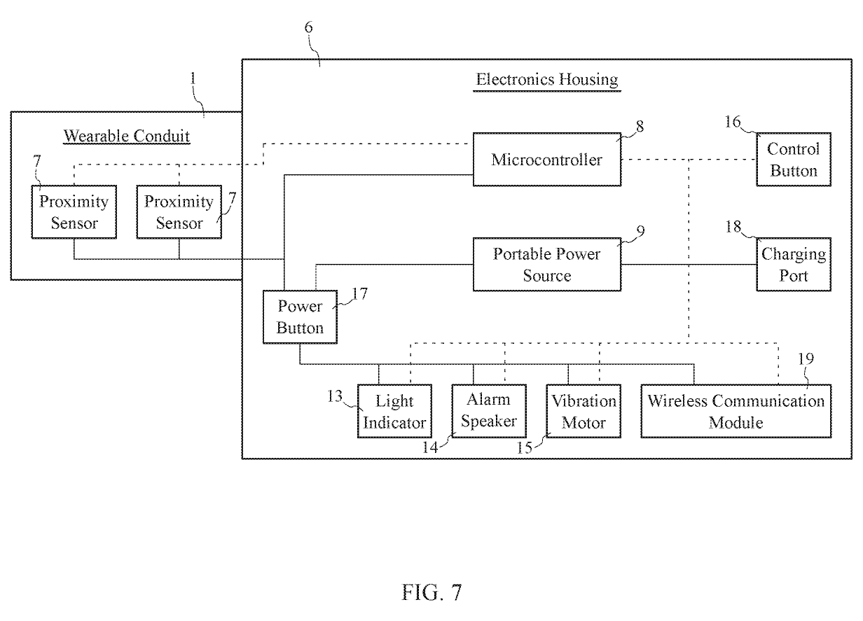

The present invention provides a wearable proximity alert device. The wearable proximity alert device helps the wearer have situational awareness and keep at least six feet away from other people or objects. The present invention is preferably provided as a wearable device that resembles common personal accessories, such as a necklace, that is comfortable to wear and does not interfere with daily activities. In the preferred embodiment, the present invention comprises a wearable conduit 1, an electronics housing 6, a plurality of proximity sensors 7, a microcontroller 8, a portable power source 9, and a conduit fastener 10, as can be seen in FIGS. 1 through 7. The wearable conduit 1 corresponds to the structure that helps secure the present invention to the user’s body. The wearable conduit 1 also allows the wiring between the electronic and electrical components implemented in the present invention. The electronics housing 6 protects the microcontroller 8 and the portable power source 9. The plurality of proximity sensors 7 allows the establishment of a social distancing safe zone around the user. The microcontroller 8 and the portable power source 9 allow the automatic operation of the present invention. The conduit fastener 10 allows the removable attachment of the present invention to the user’s body.

The general configuration of the aforementioned components allows the formation of a social distancing safe zone to alert the user when a person or object gets near the user. As previously discussed, the present invention is provided as a wearable accessory that can be comfortably worn by the user. In the preferred embodiment, the present invention is provided as a necklace that can be removably put on by the user for everyday use. As can be seen in FIGS. 1 through 7, the wearable conduit 1 is provided as an elongated tubular structure that is used as the necklace cord. So, the wearable conduit 1 comprises a first conduit end 2 and a second conduit end 3 corresponding to the terminal ends of the wearable conduit 1.

In the preferred embodiment, the present invention can be implemented as follows: the plurality of proximity sensors 7 is distributed along the wearable conduit 1 to form a social distance safe zone around the user, as can be seen in FIGS. 1 through 7. The number of proximity sensors depends on the capacity of the type of sensors used to form the desired social distance safe zone around the user. Further, each of the plurality of proximity sensors 7 is mounted into the wearable conduit 1 in such a way that each of the plurality of proximity sensors 7 is incorporated into the structure of the wearable conduit 1. Depending on the type of proximity sensor used, the plurality of proximity sensors 7 can be mounted within the wearable conduit 1 or protrude out of the wearable conduit 1 as necessary.

Further, the electronics housing 6 is centrally positioned along the wearable conduit 1 so that when the present invention is worn by the user, the electronics housing 6 is positioned near the user’s chest. Like the plurality of proximity sensors 7, the electronics housing 6 is also mounted into the wearable conduit 1 to incorporate the electronics housing 6 on the wearable conduit 1, as can be seen in FIGS. 1 through 7. The overall shape and size of the electronics housing 6 depends on the electronic and electrical components housed within. For example, the electronics housing 6 can be provided as a short cylindrical structure with a wider radius than the wearable conduit 1 and a length shorter than the wearable conduit 1. Further, the microcontroller 8 and the portable power source 9 are mounted within the electronics housing 6 so that both are protected by the electronics housing 6.

Further, the plurality of proximity sensors 7 is electronically connected to the microcontroller 8 so that the sensor signals generated by the plurality of proximity sensors 7 are relayed to the microcontroller 8 for processing, as can be seen in FIGS. 1 through 7. The plurality of proximity sensors 7 and the microcontroller 8 are also electrically connected to the portable power source 9 so that the necessary electrical power is provided to the plurality of proximity sensors 7 and the microcontroller 8 for operation. Further, the first conduit end 2 is attached to the second conduit end 3 by the conduit connector to allow the removable attachment of the wearable conduit 1 around the user’s neck.

As previously discussed, the present invention is configured to establish a social distance safety zone around the user. In the preferred embodiment, the present invention is configured to establish a six-foot safety zone around the user to prevent transmission of contagious diseases. To do so, different types of proximity sensors can be used for the plurality of proximity sensors 7. The plurality of proximity sensors 7 can be provided as a set of lidar-based sensors that utilize various light wavelengths to detect people or objects within the six-foot safety zone. The plurality of proximity sensors 7 can also be provided as a set of ultrasonic-based sensors that utilize radio wavelengths to detect people or objects within the six-foot safety zone. The plurality of proximity sensors 7 can also be provided as a set of infrared-based sensors that utilize infrared wavelengths to detect people or objects within the six-foot safety zone. In other embodiments, the plurality of proximity sensors 7 can implement other sensors that utilize different means to detect people or objects within the six-foot safety zone.

The present invention can be equipped with different means to alert the user when a person and/or object enters the social distance safety zone around the user. In one embodiment, the present invention may further comprise at least one light indicator 13 that emits a light signal to visually alert the user that a person and/or object has entered the social distance safety zone. As can be seen in FIGS. 1 through 7, the at least one light indicator 13 is integrated into the electronics housing 6 so that the at least one light indicator 13 is protected by the structure of the electronics housing 6. The at least one light indicator 13 is electronically connected to the microcontroller 8 in such a way that the at least one light indicator 13 is automatically activated by the microcontroller 8 when a person and/or object has entered the social distance safety zone. For example, when one or more proximity sensors from the plurality of proximity sensors 7 detect a person and/or object, the one or more proximity sensors generate the corresponding sensor signals that are transmitted to the microcontroller 8. The microcontroller 8 then processes the received sensor signals and activates the at least one light indicator 13 to emit the light signal. Further, the at least one light indicator 13 is electrically connected to the portable power source 9 to receive the electrical power necessary to operate. In other embodiments, several light indicators can be implemented to signal different levels of proximity.

In another embodiment, the present invention may further comprise an alarm speaker 14 that emits an audible signal to alert the user that a person and/or object has entered the social distance safety zone. As can be seen in FIGS. 1 through 7, the alarm speaker 14 is integrated into the electronics housing 6 so that the alarm speaker 14 is protected by the electronics housing 6. The alarm speaker 14 is electronically connected to the microcontroller 8 so that the alarm speaker 14 is automatically activated by the microcontroller 8 when a person and/or object has entered the social distance safety zone. For example, when one or more proximity sensors from the plurality of proximity sensors 7 detect a person and/or object, the one or more proximity sensors generate the corresponding sensor signals that are transmitted to the microcontroller 8. The microcontroller 8 then processes the received sensor signals and activates the alarm speaker 14 to emit the audible signal. Further, the alarm speaker 14 is electrically connected to the portable power source 9 to receive the electrical power necessary to operate. In other embodiments, the alarm speaker 14 can be replaced with other audible alarms that emit an audible alert to the user.

In another embodiment, the present invention may further comprise a vibration motor 15 that gently vibrates the electronics housing 6 to alert the user that a person and/or object has entered the social distance safety zone. As can be seen in FIGS. 1 through 7, the vibration motor 15 is mounted within the electronics housing 6 so that the vibration motor 15 is protected by the electronics housing 6. The vibration motor 15 is electronically connected to the microcontroller 8 so that the vibration motor 15 is automatically activated by the microcontroller 8 when a person and/or object has entered the social distance safety zone. For example, when one or more proximity sensors from the plurality of proximity sensors 7 detect a person and/or object, the one or more proximity sensors generate the corresponding sensor signals that are transmitted to the microcontroller 8. The microcontroller 8 then processes the received sensor signals and activates the vibration motor 15 to vibrate the electronics housing 6. Further, the vibration motor 15 is electrically connected to the portable power source 9 to receive the electrical power necessary to operate. In other embodiments, the vibration motor 15 can be replaced with other physical alarms that safely alert the user when a person and/or object enter the social distance safety zone.

The present invention can be configured to operate as a standalone device that operates independently from other electronic devices. In some embodiments, the present invention may further comprise at least one control button 16 that allows the user to configure the operational settings of the present invention, as can be seen in FIGS. 1 through 7. The at least one control button 16 can be provided as a mechanical switch that allows the user to configure different operational settings including, but not limited to, light color, light intensity, light pattern, sound level, sound pattern, vibration intensity, vibration pattern, etc. To do so, the at least one control button 16 is integrated into the electronics housing 6 to keep the at least one control button 16 accessible to the user. In addition, the at least one control button 16 is electronically connected to the microcontroller 8. This way, the user input from the at least one control button 16 can be relayed to the microcontroller 8 for processing and change the operational settings accordingly. In alternate embodiments, the at least one control button 16 can be provided as several control buttons, each controlling different operational settings of the present invention.

In other embodiments, the present invention may further comprise a power button 17 that allows the user to selectively turn the present invention on/off as desired, as can be seen in FIGS. 1 through 7. Like the at least one control button 16, the power button 17 can be mechanical switch that the user can manually engage to turn the present invention on and off. To do so, the power button 17 is integrated into the electronics housing 6 to keep the power button 17 accessible to the user while the present invention is worn. In addition, the plurality of proximity sensors 7 and the microcontroller 8 are electrically connected to the portable power source 9 through the power button 17. This way, when the present invention is off and the user engages the power button 17, the portable power source 9 provides the electrical power necessary for the present invention to operate. On the other hand, when the present invention is on and the user engages the power button 17, the electrical power stops being fed to the present invention so that the present invention is turned off.

Further, the portable power source 9 can be provided in different embodiments according to the power requirements of the present invention. In the preferred embodiment, the portable power source 9 is provided as a rechargeable portable battery that can be recharged as necessary. As can be seen in FIGS. 1 through 7, the present invention may further comprise a charging port 18 that allows a charging cable to be connected to the present invention to recharge the portable power source 9. The charging port 18 can be any type of common power ports including, but not limited to, Universal Serial Bus (USB) ports, that allow common charging cables to be used with the present invention. Further, the charging port 18 is integrated into the electronics housing 6 to incorporate the charging port 18 into the electronics housing 6. Furthermore, the charging port 18 is electrically connected to the portable power source 9. This way, when the corresponding charging cable is connected to the charging port 18, the electrical power from the external power source (i.e., electrical utilities) can flow into the portable power source 9. In other embodiments, the portable power source 9 can be provided as a disposable battery that can be replaced when depleted.

While the present invention is preferably provided as a standalone device, the present invention can also be provided as a wearable device that can be paired with an external computing device, such as a smartphone. As can be seen in FIGS. 1 through 7, the present invention may further comprise a wireless communication module 19 that allows the present invention to be paired to an external computing device. The wireless communication module 19 allows the processed signals from the microcontroller 8 to be wirelessly relayed to the external computing device. This way, the external computing device alerts the user when a person and/or object has entered the social distance safe zone instead of the present invention. For example, when one or more proximity sensors from the plurality of proximity sensors 7 detect a person and/or object, the one or more proximity sensors generate the corresponding sensor signals that are transmitted to the microcontroller 8. The microcontroller 8 then processes the received sensor signals and relays the processed signals to the wireless communication module 19 which are then wirelessly transmitted to the external computing device. Then, the external computing device can alert the user using the technological capabilities of the external computing device. For example, the smartphone can vibrate, emit a sound alert, or emit a light signal as necessary.

The wireless communication module 19 can be implemented as follows: the wireless communication module 19 is mounted within the electronics housing 6 in such a way that the wireless communication module 19 is protected by the structure of the electronics housing 6, as can be seen in FIGS. 1 through 7. Further, the wireless communication module 19 is electronically connected to the microcontroller 8 so that the processed signals from the microcontroller 8 can be relayed to the wireless communication module 19. Furthermore, the wireless communication module 19 is electrically connected to the portable power source 9 to receive the electrical power necessary for operation. In other embodiments, different communication technologies can be implemented that allow the present invention to operate along with external computing devices or other wearable devices.

As previously discussed, the wearable conduit 1 is provided as a necklace cord that allows the user to wear the present invention around the neck. As can be seen in FIGS. 1 through 7, to allow the user to removably put on the present invention around the neck, the conduit fastener 10 is preferably an interlocking fastener that can be selectively engaged to connect the first conduit end 2 to the second conduit end 3. For example, the conduit fastener 10 can be provided as a clasp that allows the user to removably secure the wearable conduit 1 around the neck. To do so, the conduit fastener 10 may comprise a first interlocking piece 11 and a second interlocking piece 12 corresponding to the two interlocking pieces of the conduit fastener 10. For example, the first interlocking piece 11 can be the hook portion of the conduit fastener 10, while the second interlocking piece 12 can be the loop portion of the conduit fastener 10.

The first interlocking piece 11 and the second interlocking piece 12 can be implemented as follows: the first interlocking piece 11 is connected onto the first conduit end 2 to secure the first interlocking piece 11 to the first conduit end 2, as can be seen in FIGS. 1 through 7. On the other hand, the second interlocking piece 12 is connected onto the second conduit end 3 to secure the second interlocking piece 12 to the second conduit end 3. Further, to secure the wearable conduit 1 around the user’s neck, the first interlocking piece 11 is engaged to the second interlocking piece 12. In other embodiments, the conduit fastener 10 can be modified to allow the removably attachment of the wearable conduit 1 to different parts of the user’s body.

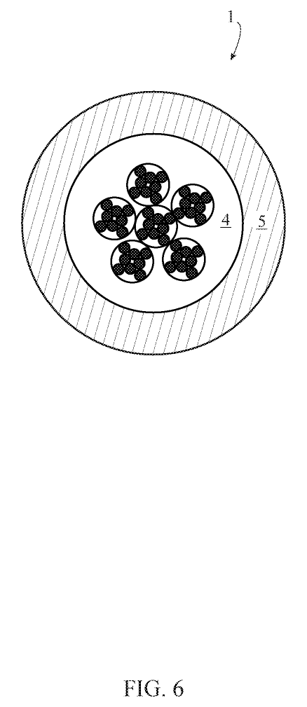

As previously discussed, the wearable conduit 1 allows the electronic and electrical connections of the plurality of proximity sensors 7 to the microcontroller 8 and portable power source 9, respectively, while allowing the wearable conduit 1 to be comfortably worn. As can be seen in FIG. 6, the wearable conduit 1 may comprise a malleable core 4 and a tactile-safe jacket 5. The malleable core 4 corresponds to the flexible structure of the wearable conduit 1 that houses the wiring used to transmit the electronic and electrical signals. The tactile-safe jacket 5 corresponds to the outer structure of the wearable conduit 1 that protects the malleable core 4 and prevents damage the user’s body while the present invention is being worn. The malleable core 4 is enclosed within the tactile-safe jacket 5 so that the malleable core 4 is protected by the tactile-safe jacket 5. In other embodiments, the wearable conduit 1 can be modified to accommodate other features.

Although the invention has been explained in relation to its preferred embodiment, it is to be understood that many other possible modifications and variations can be made without departing from the spirit and scope of the invention.

What is claimed is:

1. A wearable proximity alert device comprising:
a wearable conduit;
an electronics housing;
a plurality of proximity sensors;
a microcontroller;
a portable power source;
a conduit fastener;
the wearable conduit comprising a first conduit end and a second conduit end;
the plurality of proximity sensors being distributed along the wearable conduit;
each of the plurality of proximity sensors being mounted into the wearable conduit;
the electronics housing being centrally positioned along the wearable conduit;
the electronics housing being mounted into the wearable conduit;
the microcontroller and the portable power source being mounted within the electronics housing;
the plurality of proximity sensors being electronically connected to the microcontroller;
the plurality of proximity sensors and the microcontroller being electrically connected to the portable power source; and
the first conduit end being attached to the second conduit end by the conduit connector.

2. The wearable proximity alert device as claimed in claim 1, wherein the plurality of proximity sensors is a set of lidar-based sensors.

3. The wearable proximity alert device as claimed in claim 1, wherein the plurality of proximity sensors is a set of ultrasonic-based sensors.

4. The wearable proximity alert device as claimed in claim 1, wherein the plurality of proximity sensors is a set of infrared-based sensors.

5. The wearable proximity alert device as claimed in claim 1 further comprising:
at least one light indicator;
the at least one light indicator being integrated into the electronics housing;
the at least one light indicator being electronically connected to the microcontroller; and
the at least one light indicator being electrically connected to the portable power source.

6. The wearable proximity alert device as claimed in claim 1 further comprising:
an alarm speaker;
the alarm speaker being integrated into the electronics housing;
the alarm speaker being electronically connected to the microcontroller; and
the alarm speaker being electrically connected to the portable power source.

7. The wearable proximity alert device as claimed in claim 1 further comprising:
a vibration motor;
the vibration motor being mounted within the electronics housing;
the vibration motor being electronically connected to the microcontroller; and
the vibration motor being electrically connected to the portable power source.

8. The wearable proximity alert device as claimed in claim 1 further comprising:
at least one control button;
the at least one control button being integrated into the electronics housing; and
the at least one control button being electronically connected to the microcontroller.

9. The wearable proximity alert device as claimed in claim 1 further comprising:
a power button;
the power button being integrated into the electronics housing; and
the plurality of proximity sensors and the microcontroller being electrically connected to the portable power source through the power button.

10. The wearable proximity alert device as claimed in claim 1 further comprising:
a charging port;
the charging port being integrated into the electronics housing; and
the charging port being electrically connected to the portable power source.

11. The wearable proximity alert device as claimed in claim 1 further comprising:
a wireless communication module;
the wireless communication module being mounted within the electronics housing;
the wireless communication module being electronically connected to the microcontroller; and
the wireless communication module being electrically connected to the portable power source.

12. The wearable proximity alert device as claimed in claim 1 further comprising:
the conduit fastener comprising a first interlocking piece and a second interlocking piece;
the first interlocking piece being connected onto the first conduit end;
the second interlocking piece being connected onto the second conduit end; and
the first interlocking piece being engaged to the second interlocking piece.

13. The wearable proximity alert device as claimed in claim 1 further comprising:
the wearable conduit comprising a malleable core and a tactile-safe jacket; and
the malleable core being enclosed within the tactile-safe jacket.

14. A wearable proximity alert device comprising:
a wearable conduit;
an electronics housing;
a plurality of proximity sensors;
a microcontroller;
a portable power source;
a conduit fastener;
a charging port;
the wearable conduit comprising a first conduit end and a second conduit end;
the wearable conduit comprising a malleable core and a tactile-safe jacket;
the conduit fastener comprising a first interlocking piece and a second interlocking piece;
the malleable core being enclosed within the tactile-safe jacket;
the plurality of proximity sensors being distributed along the wearable conduit;
each of the plurality of proximity sensors being mounted into the wearable conduit;
the electronics housing being centrally positioned along the wearable conduit;
the electronics housing being mounted into the wearable conduit;
the microcontroller and the portable power source being mounted within the electronics housing;
the charging port being integrated into the electronics housing;
the plurality of proximity sensors being electronically connected to the microcontroller;
the plurality of proximity sensors, the microcontroller, and the charging port being electrically connected to the portable power source;
the first interlocking piece being connected onto the first conduit end;
the second interlocking piece being connected onto the second conduit end; and
the first interlocking piece being engaged to the second interlocking piece.

15. The wearable proximity alert device as claimed in claim 14, wherein the plurality of proximity sensors is a set of lidar-based sensors.

16. The wearable proximity alert device as claimed in claim 14, wherein the plurality of proximity sensors is a set of ultrasonic-based sensors.

17. The wearable proximity alert device as claimed in claim 14, wherein the plurality of proximity sensors is a set of infrared-based sensors.

18. The wearable proximity alert device as claimed in claim 14 further comprising:
at least one light indicator;
an alarm speaker;
a vibration motor;
the at least one light indicator and the alarm speaker being integrated into the electronics housing;
the vibration motor being mounted within the electronics housing;
the at least one light indicator, the alarm speaker, and the vibration motor being electronically connected to the microcontroller; and
the at least one light indicator, the alarm speaker, and the vibration motor being electrically connected to the portable power source.

19. The wearable proximity alert device as claimed in claim 14 further comprising:
at least one control button;
a power button;
the at least one control button and the power button being integrated into the electronics housing;
the at least one control button being electronically connected to the microcontroller; and
the plurality of proximity sensors and the microcontroller being electrically connected to the portable power source through the power button.

20. The wearable proximity alert device as claimed in claim 14 further comprising:
a wireless communication module;
the wireless communication module being mounted within the electronics housing;
the wireless communication module being electronically connected to the microcontroller; and
the wireless communication module being electrically connected to the portable power source.
